(19) United States
(12) Patent Application Publication
(10) Pub. No.: US 2026/0175741 A1
(43) Pub. Date: Jun. 25, 2026

(54) ELECTRIFIED VEHICLE

(71) Applicant: TOYOTA JIDOSHA KABUSHIKI KAISHA, Toyota-shi (JP)

(72) Inventors: Hiroto AMADA, Nagakute-shi (JP); Noritaka Takuda, Okazaki-shi (JP)

(73) Assignee: TOYOTA JIDOSHA KABUSHIKI KAISHA, Toyota-shi (JP)

(21) Appl. No.: 19/343,434

(22) Filed: Sep. 29, 2025

(30) Foreign Application Priority Data
Dec. 19, 2024 (JP) 2024-223861

(51) Int. Cl. B60L 58/27; B60L 58/13; H01M 10/615; H01M 10/625; H01M 10/633; H01M 10/6571

(52) U.S. Cl. CPC B60L 58/27; B60L 58/13; H01M 10/615; H01M 10/625; H01M 10/633; H01M 10/6571; H01M 2220/20

(57) ABSTRACT

Electrified vehicle includes a power storage device for storing power for traveling, and a heater for heating the power storage device using the power of the power storage device. A controller for controlling heating of the power storage device by the heater includes a selection unit for selecting a manual temperature rise mode for executing temperature rise control of the power storage device based on a manual operation of an occupant, and an automatic temperature rise mode for executing temperature rise control of the power storage device based on a detection signal obtained by detecting the traveling state, and a temperature rise control unit for suppressing the temperature rise of the power storage device by the manual temperature rise mode when a predetermined first condition is satisfied, and suppressing the temperature rise of the power storage device by the automatic temperature rise mode when a predetermined second condition is satisfied.

### CROSS-REFERENCE TO RELATED APPLICATION

This application claims priority to Japanese Patent Application No. 2024-223861 filed on Dec. 19, 2024. The disclosure of the above-identified application, including the specification, drawings, and claims, is incorporated by reference herein in its entirety.

### BACKGROUND

### 1. Technical Field

The present disclosure relates to an electrified vehicle capable of traveling by electric power of a power storage device mounted on the vehicle, and more particularly, to an electrified vehicle equipped with a system that heats a power storage device and raises the temperature of the power storage device.

### 2. Description of Related Art

Battery electric vehicles (BEVs), plug-in hybrid electric vehicles (PHEVs), etc. are known as electrified vehicles of this type. These electrified vehicles are equipped with a large-capacity power storage device, and travel by driving a motor with electric power of the power storage device. Therefore, when the remaining charge amount (state of charge: SOC) in the power storage device serving as an energy source is reduced, it is necessary to move to a place where a charging facility such as a charging station is installed and charge the power storage device.

A secondary battery such as a lithium-ion battery is used as the power storage device of the electrified vehicles. The secondary battery of this type is discharged as expected and is charged in a short time at a certain high temperature. Therefore, a battery device described in Japanese Unexamined Patent Application Publication No. 2003-223938 (JP 2003-223938 A), for example, is configured to warm a secondary battery using a plurality of heaters provided in a warming plate. Further, in the battery device described in JP 2003-223938 A, the secondary battery is warmed when an ignition switch is turned on and the temperature of the secondary battery is low. The energization of the heaters is stopped when the battery temperature becomes higher than a set temperature by warming of the secondary battery.

### SUMMARY

In the battery device described in JP 2003-223938 A, the warming of the secondary battery is performed in a state in which the ignition switch is turned on. The power supply is a commercial power supply for household use, for example, and power is supplied to the heaters via an alternating-current (AC)/direct-current (DC) converter. Therefore, in the battery device described in JP 2003-223938 A, the warming of the secondary battery is performed in a state in which the vehicle is stopped. In this case, if the warming and the charging of the secondary battery are performed concurrently, the charging speed may be low due to the fact that the temperature of the secondary battery is not sufficiently high at the beginning of the charging, and there is a possibility that as a result, a long charging time will be required. Further, when the vehicle travels after warming the secondary battery, the temperature of the secondary battery may gradually become lower, and the temperature of the secondary battery may become lower than a temperature suitable for charging at the time of charging.

The performance of discharging or charging the power storage device is high when the temperature of the power storage device is high to a degree, and therefore, when charging is performed, it is preferable to raise the temperature of the power storage device in advance. This control of raising the temperature in preparation for charging is called preconditioning. Since the temperature rise of the power storage device by preconditioning is performed prior to charging, an in-vehicle power storage device is used as the power supply. The power storage device is also used as a power supply for travel. Therefore, if electric power is consumed to raise the temperature of the power storage device, the remaining charge amount (SOC) of the power storage device is reduced, and the travelable distance of the vehicles is affected. More specifically, scheduled travel may not be completed, depending on the degree and timing of the temperature rise of the power storage device. Conventionally, the mode, control, etc. of the temperature rise of the power storage device prior to the charging have not been sufficiently studied, and there is much room for developing a new technique in order to efficiently raise the temperature of the power storage device while maintaining a sufficient travelable distance.

The present disclosure has been made in view of the above circumstances, and provides an electrified vehicle equipped with a new technique capable of efficiently raising the temperature of a power storage device during travel prior to charging while maintaining a sufficient travelable distance.

In order to achieve the above object, an aspect of the present disclosure provides
an electrified vehicle including a power storage device that stores electric power for travel, and a heater that heats the power storage device using the electric power of the power storage device, the electrified vehicle including
a controller that controls heating of the power storage device by the heater, in which the controller includes:
a selection unit that selects a manual temperature rise mode for executing temperature rise control for the power storage device based on a manual operation of an occupant and an automatic temperature rise mode for executing the temperature rise control for the power storage device based on a detection signal obtained by detecting a travel state; and
a temperature rise control unit that suppresses a temperature rise of the power storage device by the manual temperature rise mode when a predetermined first condition is satisfied, and suppresses the temperature rise of the power storage device by the automatic temperature rise mode when a predetermined second condition different from the first condition is satisfied.

In an aspect of the present disclosure, the temperature rise control unit may be configured not to suppress the temperature rise of the power storage device in the automatic temperature rise mode when the first condition is satisfied and the second condition is not satisfied.

In an aspect of the present disclosure,
the controller may further include
a remaining charge amount detection unit that detects a remaining charge amount of the power storage device, and
a remaining distance calculation unit that determines a remaining distance that is a travel distance to a destination;
the first condition may be that the remaining charge amount of the power storage device is equal to or less than a predetermined threshold value; and
the second condition may be that a distance that is travelable with the remaining charge amount of the power storage device is equal to or less than the remaining distance.

In the present disclosure, the destination may be either a point selected and set by the occupant or a point provided with a charging facility and located ahead in a travel direction.

In the electrified vehicle of the present disclosure, the manual temperature rise mode and the automatic temperature rise mode can be selected as the control for raising the temperature of the power storage device during travel. In the manual temperature rise mode, the heating and temperature rise of the power storage device by a heater is executed by a manual operation by an occupant. In the automatic temperature rise mode, the heating and temperature rise of the power storage device by a heater is executed based on a travel state. The temperature rise in these modes is suppressed when a predetermined condition is satisfied. The condition is different between the manual temperature rise mode and the automatic temperature rise mode. Therefore, it is possible to manage the temperature rise of the power storage device, that is, the remaining charge amount of the power storage device, while satisfying a temperature rise request from the occupant as much as possible, and it is possible to raise the temperature of the power storage device while ensuring the possibility of travel to the destination. That is, it is possible to efficiently raise the temperature of the power storage device while securing travel with the electric power remaining in the power storage device during travel, and consequently, it is possible to shorten the charging time by bringing the temperature of the power storage device during charging after the stop closer to a temperature suitable for charging.

In particular, the first condition is that the remaining charge amount of the power storage device is equal to or less than a predetermined threshold value. As a result, it is possible to suppress the cruising distance becoming shorter as the temperature of the power storage device rises, and thus the occupant feeling uncomfortable.

Further, when the second condition is that the distance that is travelable with the remaining charge amount is equal to or less than the remaining distance to the destination, it is possible to reliably complete travel to the destination.

Further, in the electrified vehicle of the present disclosure, the temperature of the power storage device can be raised in the automatic temperature rise mode, even if the temperature rise of the power storage device is suppressed in the manual temperature rise mode. Therefore, the temperature of the power storage device can be raised at least to a certain degree by selecting the automatic temperature rise mode.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a vehicle;

FIG. 2 is a diagram illustrating a change in temperature of the power storage device in the manual temperature rise mode and a change in temperature of the power storage device in the automatic temperature rise mode;

FIG. 3 is a block-diagram illustrating a functional configuration of controllers; and

FIG. 4 is a flowchart for explaining a control example executed by the controller.

### DETAILED DESCRIPTION OF EMBODIMENTS

Embodiments of the present disclosure will now be described with reference to the accompanying drawings. Note that the embodiments described below are merely examples of the implementation of the present disclosure, and are not intended to limit the present disclosure.

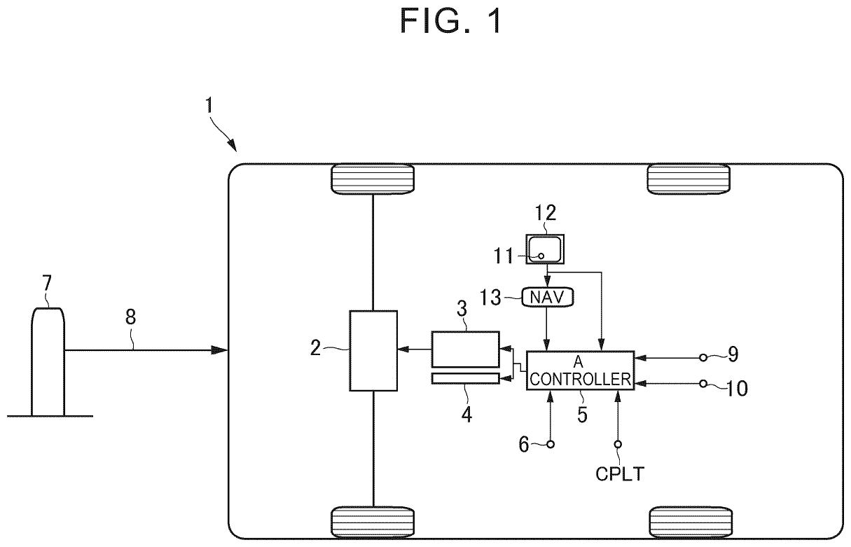

FIG. 1 schematically illustrates an example of a vehicle 1 according to an embodiment of the present disclosure. Vehicle 1 is an electrified vehicle that travels by means of torques outputted by a driving power source 2 including an electric motor, and battery electric vehicle (BEV) and plug-in hybrid electric vehicle (PHEV) are examples. A power storage device 3 that supplies electric power to the driving power source 2 and charges electric power generated by an electric motor is mounted on the vehicle 1. The power storage device 3 may be constituted by a secondary battery such as a lithium-ion battery. Since the power storage device 3 has characteristics in which the charging speed varies depending on the temperature, a heater 4 is provided for heating the power storage device 3 to a temperature suitable for charging and raising the temperature (raising the temperature). The heater 4 may be a heater having a heating element that generates heat by electricity, or may be a heater configured to heat the power storage device 3 by heat transferred from an air conditioning system (not shown), for example. In any case, the power storage device 3 is configured to consume power and generate heat.

A control device (controller) 5 for controlling the temperature rise of the power storage device 3 by the heater 4 is provided. The controllers 5 are mainly composed of a microcomputer including an arithmetic unit (CPU), a storage device (ROM, RAM, SRAM), an interface, and the like. The controller 5 performs an operation according to a program prepared in advance using the input data and the data stored in advance, and outputs a result of the operation as a control command signal. As an example of the input data, a signal such as on/off of the main switch 6 is input. The main switch 6 is a switch that is turned on to activate the entire vehicle 1, and is turned off to deactivate the entire vehicle 1. The main switch 6 may be referred to as an ignition switch or a ready switch. The controller is operable even when the main switch 6 is in the off state.

In addition, a pilot-control (CPLT) signal is inputted to the controller 5. The power storage device 3 is charged by being connected to an external charging facility 7 such as a charging station via a charging cable 8. When the charging cable 8 is connected to the vehicle 1, a CPLT signal for controlling charging is transmitted between the charging facility 7 and the vehicle 1. CPLT is inputted to the controllers 5. Since the controller 5 is for controlling the temperature of the power storage device 3, a detection signal of the temperature sensor 9 for detecting the temperature of the power storage device 3 and a detection signal of the outside air temperature sensor 10 for detecting the outside air temperature are input to the controller 5. Further, the remaining charge amount (SOC), which is the amount of electric power remaining in the power storage device 3, is inputted to the controllers 5.

The controller 5 includes a manual temperature rise mode (hereinafter, referred to as a manual mode) and an automatic temperature rise mode (hereinafter, referred to as an automatic mode) as modes for controlling the temperature-raising of the power storage device 3. The manual mode is a control mode in which the temperature rise is started by manual operation by an occupant such as a driver of the vehicle 1, and the temperature rise is ended by establishing a predetermined end condition such as the temperature of the power storage device 3 reaching the target temperature. The automatic mode is a control mode in which the temperature rise is started based on a signal that detects the state of the vehicle 1 such as the position of the vehicle 1, and the temperature rise is ended when a predetermined end condition such as the temperature of the power storage device 3 reaching the target temperature is satisfied. A signal of the selection switch 11 for selecting these control modes is input to the controller 5. The selection switch 11 may be a contact switch such as a push switch or a touch-type switch appearing as an icon on the touch panel 12. FIG. 1 schematically illustrates a selection switch 11 appearing on the touch panel 12.

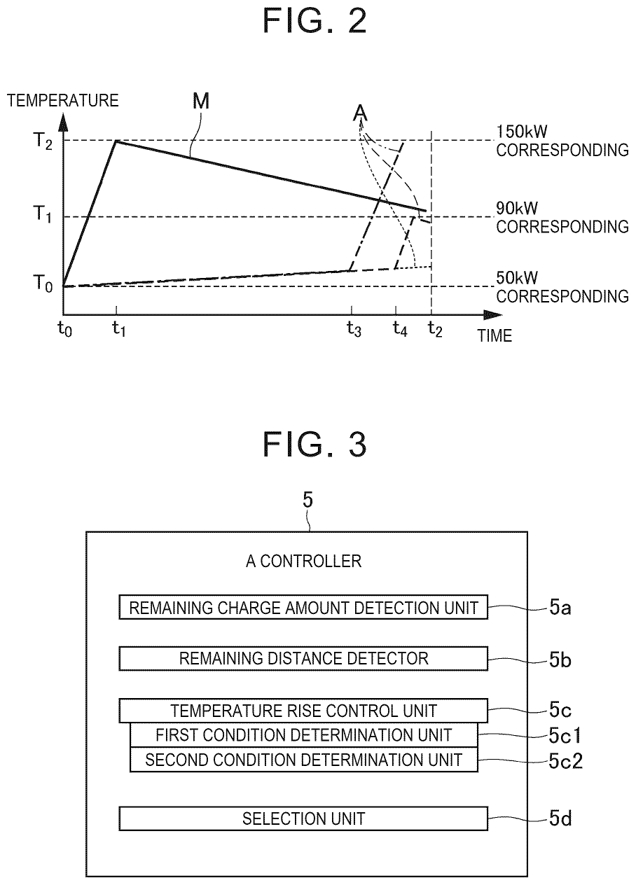

Here, the manual mode and the automatic mode will be described. The manual mode is a control mode in which the heater 4 is operated to raise the temperature by selecting the manual mode by the selection switch 11 while the vehicle 1 is traveling in preparation for charging by the charging facility 7. When the main switch 6 is in the ON state, the manual mode may be selected by the selection switch 11. An example of a change in temperature of the power storage device 3 is shown in FIG. 2. FIG. 2 is a diagram in which the temperature of the power storage device 3 is taken on the vertical axis and time is taken on the horizontal axis, in which a line indicated by reference numeral “M” indicates a change in the manual mode, and a line indicated by reference numeral “A” indicates a change in the automatic mode. When the manual mode is selected by the selection switch 11 at to time point, electric power is supplied to the heaters 4, the power storage device 3 starts to be heated, and the temperature of the power storage device 3 gradually increases. The method of raising the temperature is determined by the amount of heat generated by the heater 4, the thermal resistance between the heater 4 and the power storage device 3, the amount of heat dissipated from the power storage device 3 that is affected by the outside air temperature, and the like.

The temperature of the power storage device 3 suitable for charging varies depending on the charging capacity of the charging facility 7, and is about T0° C. when the temperature is about 50 kW, about T1 (>T0) ° C. when the temperature is 90 kW, and about T2 (>T1) ° C. when the temperature is 150 KW. When charging is not scheduled in particular, or when the capacity of the charging facility 7 for charging is unknown even if the charging is scheduled, the temperature corresponding to the maximum capacity assumed (e.g., T2° C.) as the target temperature is raised. Therefore, in the embodiment illustrated in FIG. 2, the energization of the heaters 4 is stopped at t1 point in time when the detected temperature of the power storage device 3 reaches the target temperature, and the temperature rise of the power storage device 3 is stopped. Thereafter, the temperature of the power storage device 3 gradually decreases due to natural heat dissipation. Consequently, at t2 point in time when charging is performed, the temperature of the power storage device 3 may be lower than a temperature suitable for charging. Therefore, the manual mode is a control mode in which the temperature rise is performed with priority given to the intention of the temperature rise of the occupant that appears when the selection switch 11 is manually operated.

The automatic mode is a control mode in which the temperature of the power storage device 3 is raised based on the traveling state of the vehicle 1 on condition that the automatic mode is selected. The traveling state of the vehicle 1 is mainly a distance from the current position of the vehicle 1 to the charging facility 7 or a time until the vehicle reaches the charging facility 7. The charging facility 7 may be a facility at a point detected based on map data or the like, or may be a facility at a point set as a target point. Therefore, in the automatic mode, the temperature rise control is performed on the basis of the current position of the vehicle 1 and the position of the charging facility 7, so that the data obtained by the navigation system 13 is used. The navigation system 13 is a system that obtains the position of the vehicle 1 and the charging facility 7 by GPS (Global Positioning System), and obtains the position of the vehicle 1 and the charging facility 7 on the map by superimposing the position information obtained by GPS on the map data prepared in advance. Therefore, according to the navigation system 13, it is possible to obtain the distance from the current position to the point of the charging facility 7, the time or the time until the point of the charging facility 7 is reached when the vehicle travels at a predetermined vehicle speed, and the like. Further, the capacity of the charging facility 7 can be obtained from the navigation system 13 by being stored in advance in the navigation system 13.

On the other hand, based on the difference between the current temperature and the target temperature of the power storage device 3, a time for raising the temperature to the target temperature is determined, and therefore, from the time and the vehicle speed, a temperature rise start timing such as a time at which the temperature rise is started or a distance from the charging facility 7 is determined. Therefore, when the target charging facility 7 is a 150 KW facility, as indicated by reference numeral “A” in FIG. 2, the temperature rise is started at t3 time point, and when the target charging facility 7 is a 90 kW facility, the temperature rise is started at a t4 time point that is further closer to the charging facility. Also in the automatic mode, the temperature rise is stopped when the temperature of the power storage device 3 reaches the target temperature.

Note that the data stored in the controller 5 in advance are thresholds for determining the amount of SOC of the power storage device 3 in the manual mode, the travelable distance for each remaining charge amount (SOC), the temperature of the power storage device 3 requiring a temperature rise, and the like. The threshold value for SOC of the power storage device 3 may be a value that guarantees a predetermined travel distance as a specification of the vehicle 1.

The controller 5 performs control such as execution and stopping of the temperature rise of the power storage device 3 or suppression and permission of the temperature rise again by using input data or data stored in advance. Various functions are provided for the control. FIG. 3 is a block diagram illustrating a functional configuration of the controller 5, and the controller 5 includes a remaining charge amount detection unit 5a that detects SOC of the power storage device 3. SOC of the power storage device 3 is consumed by the driving power source 2 when the vehicle 1 travels, is consumed by auxiliary machines such as an air conditioning system and heaters 4, and is charged by regenerative energy at the time of braking of the vehicle 1. Since SOC of the power storage device 3 is detected by a microcomputer (not shown) for the power storage device 3 and input to the controller 5, the remaining charge amount detection unit 5a detects SOC of the power storage device 3 based on the input SOC. Therefore, the remaining charge amount detection unit 5a may also function as a part of the microcomputer for the power storage device 3.

The remaining distance calculation unit 5b is provided in the controllers 5. The remaining distance is a distance from the current position of the vehicle 1 to the destination. The current position and the destination of the vehicle 1 can be detected by the above-described navigation system 13, and the distance from the current position to the destination can be obtained from the map data held by the navigation system 13. Note that the destination may be a position set by the occupant of the vehicle 1 in the navigation system 13, or may be a point of the charging facility 7 existing forward in the traveling direction of the vehicle 1, or a point registered as a “home”.

The controller 5 includes a temperature rise control unit 5c that controls stopping or suppressing the temperature rise and permitting the temperature rise. The temperature rise control unit 5c includes a first condition determination unit 5c1 that determines the establishment of the first condition for the manual mode, and a second condition determination unit 5c2 that determines the establishment of the second condition for the automatic mode.

The first condition is a condition for stopping or suppressing the temperature rise control in the manual mode (hereinafter, these are collectively referred to as suppressed), and an exemplary condition is that SOC of the power storage device 3 at the present time point of the vehicle 1 becomes equal to or less than a predetermined threshold value. As described above, the thresholds are SOC enough to travel a predetermined distance as the specifications of the vehicle 1. Therefore, even when the manual mode is selected by the selection switch 11 and the temperature of the power storage device 3 is low enough to require a temperature rise, if the first condition is satisfied, the first condition determination unit 5c1 makes a determination of suppression, and the heating of the power storage device 3 by the heaters 4 is suppressed. The temperature of the power storage device 3 can be obtained by the temperature sensor 9 described above. SOC is inputted to the controller 5 from a computer (not shown) that controls the power storage device 3, and is detected by the remaining charge amount detection unit 5a described above.

The second condition is a condition for suppressing the temperature rise control in the auto-mode, and an example thereof is that a distance that can be traveled by SOC at the present time of the vehicle 1 is equal to or less than a remaining distance that is a distance from the present location to the destination. Therefore, even if the automatic mode is selected by the selection switch 11 and the temperature of the power storage device 3 is low enough to require a temperature rise and the vehicle 1 approaches the destination, if the second condition is satisfied, the second condition determination unit 5c2 makes a determination of suppression, and the heating of the power storage device 3 by the heaters 4 is suppressed.

The temperature of the power storage device 3 can be obtained by the temperature sensor 9 described above. SOC is inputted from a computer (not shown) that controls the power storage device 3 to the controllers 5. In addition, since SOC and the travel function distance can be obtained in advance by experimentation, simulations, or the like and inputted to the controllers 5, the distance that can be traveled in SOC at the present time can be obtained based on these data. Further, the current position and the destination of the vehicle 1 can be detected by the above-described navigation system 13, and the remaining distance from the current position to the destination is detected by the above-described remaining distance calculation unit 5b.

A selection unit 5d for selecting the manual mode and the automatic mode described above is provided in the controllers 5. The selection unit 5d selects one of the manual mode and the automatic mode based on the signal inputted from the selection switch 11 described above, and selects that the mode is not any of the modes. The controller 5 executes the temperature rise control of the power storage device 3 in accordance with the selected control mode, and suppresses or cancels the suppression of the temperature rise control in accordance with whether the first condition or the second condition is satisfied.

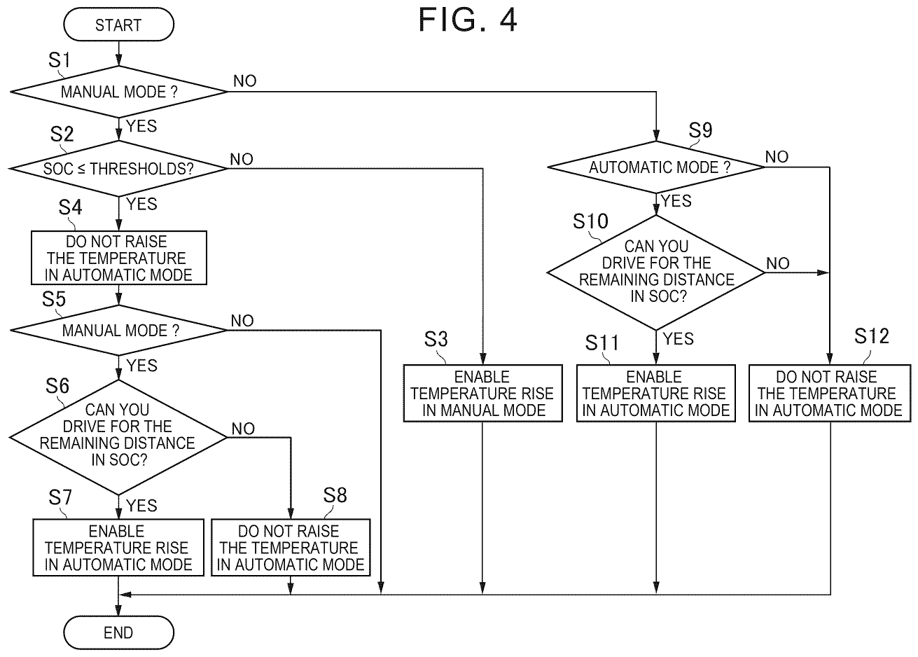

Next, an example of the temperature rise control performed by the controller 5 will be described with reference to a flowchart shown in FIG. 4. The routine illustrated in FIG. 4 is repeatedly executed at predetermined short time intervals, and first, it is determined whether or not the manual mode described above is selected as a control mode of so-called preconditioning for raising the temperature of the power storage device 3 during traveling in S1. When the manual mode is selected by the selection switch 11 and the determination of S1 is “yes”, S2 determines whether or not SOC of the power storage device 3 is equal to or less than the above-described thresholds. That is, it is determined whether or not the above-described first condition is satisfied. As described above, the thresholds define an SOC for ensuring that the vehicles 1 travel at a predetermined distance. Therefore, when S2 determination is “no”, that is, when SOC at the present time is sufficiently large, the process proceeds to S3 to allow the temperature rise in the manual mode, and thereafter, the routine of FIG. 4 is temporarily ended. Therefore, even if the manual mode is selected without being particularly limited, the temperature of the power storage device 3 can be increased while the vehicle 1 is traveling.

On the other hand, when S2 determination is “yes”, the process proceeds to S4, and the temperature rise control by the manual mode is suppressed. That is, even when the manual mode is selected and the temperature of the power storage device 3 is lower than the above-described target temperature, the heater 4 does not heat or raise the temperature of the power storage device 3.

Next, S5 is performed to determine whether or not the auto-mode has been selected. That is, while the vehicle 1 is traveling, the selection switch 11 can be operated to switch the temperature rise control mode from the manual mode to the automatic mode, and S5 determines whether or not such a control mode has been switched.

When S5 determination is “no”, the routine illustrated in FIG. 4 is temporarily ended. On the contrary, when the determination of S5 is “yes”, the process proceeds to S6, and it is determined whether or not the travelable distance in the current SOC is equal to or more than the remaining distance from the current point of the vehicle 1 to the destination. That is, it is determined whether the above-described second condition is not satisfied.

When the determination of S6 is “yes” because the travelable distance in the current SOC is equal to or more than the remaining distance, the process proceeds to S7, and the temperature rise control in the auto-mode is permitted, and thereafter, the routine illustrated in FIG. 4 is temporarily ended. Therefore, the distance to the destination is shortened, and other requirements such as the temperature of the power storage device 3 being lower than the target temperature are satisfied, so that the heater 4 heats the power storage device 3 and raises the temperature. On the contrary, when S6 determination is “no”, the process proceeds to S8, and the temperature rise control in the auto-mode is suppressed, and thereafter, the routine shown in FIG. 4 is temporarily ended. Therefore, even if the distance to the destination is shortened and other requirements such as the temperature of the power storage device 3 being lower than the target temperature are satisfied, the temperature rise of the power storage device 3 by the heater 4 is not executed.

As described above, even in a state in which the temperature rise in the manual mode is suppressed, the temperature rise control in the automatic mode is possible. This is because in the automatic mode, it is possible to give priority to securing the amount of electric power required to travel to the destination.

On the other hand, when the manual mode is not selected by the selection switch 11 and thus the determination of S1 is “no”, the process proceeds to S9 to determine whether or not the auto mode is selected. The determination steps are similar to S5 described above. Thus, when the outcome of S9 determination is “yes”, it is determined whether or not the remaining distance can be traveled in the present SOC as in the above-described S6 and S7 (S10). When the result of the determination is “yes”, the temperature rise control in the auto mode is permitted (S11), and thereafter, the routine of FIG. 4 is temporarily ended. When the result of the determination of S9 and the result of the determination of S10 are “no”, the process proceeds to S12, and the temperature rise control in the auto-mode is suppressed, and thereafter, the routine shown in FIG. 4 is temporarily ended. This is similar to the control in S8 described above.

Therefore, according to the above-described control, when there is a possibility that the amount of electric power for traveling to the destination is insufficient, the temperature rise of the automatic mode for consuming the electric power of the power storage device 3 is suppressed, so that the vehicle can reliably travel to the destination. Further, since the temperature of the power storage device 3 is increased within the range, the temperature of the power storage device 3 at the time of charging can be brought close to the target temperature, and the charging time can be shortened.

In the above-described S2, SOC is compared with the thresholds, and the travelable range is calculated based on SOC in S6 and S9. SOC may be a detected SOC, or may be a remaining charge amount obtained by subtracting, from the detected SOC, an amount of electric power expected to be consumed at the elevated temperature. Note that the amount of electric power consumed at the temperature rise can be obtained from the amount of heat based on the difference between the current temperature of the power storage device 3 and the target temperature and the heat capacity of the member to be heated including the power storage device 3.

Although an embodiment of the present disclosure has been described above, the present disclosure is not limited to the above-described embodiment, and can be appropriately modified and implemented. For example, after the temperature rise control in the manual mode is suppressed as described above, the manual mode is turned off by canceling the selection of the manual mode by the selection switch 11. When the manual mode is selected again by the selection switch 11 after the manual mode is turned off in this way, the temperature rise control in the manual mode may be permitted even if SOC at that time is less than or equal to the threshold. This is because, once the temperature rise in the manual mode is suppressed and the selection of the manual mode is cancelled, if the occupant chooses the temperature rise in the manual mode intentionally, it is considered that some special circumstance has occurred, and it is preferable to prioritize the intention of the occupant.

What is claimed is:

1. An electrified vehicle including a power storage device that stores electric power for travel, and a heater that heats the power storage device using the electric power of the power storage device, the electrified vehicle comprising
a controller that controls heating of the power storage device by the heater, wherein
the controller includes:
a selection unit that selects a manual temperature rise mode for executing temperature rise control for the power storage device based on a manual operation of an occupant and an automatic temperature rise mode for executing the temperature rise control for the power storage device based on a detection signal obtained by detecting a travel state; and
a temperature rise control unit that suppresses a temperature rise of the power storage device by the manual temperature rise mode when a predetermined first condition is satisfied, and suppresses the temperature rise of the power storage device by the automatic temperature rise mode when a predetermined second condition different from the first condition is satisfied.

2. The electrified vehicle according to claim 1, wherein the temperature rise control unit is configured not to suppress the temperature rise of the power storage device in the automatic temperature rise mode when the first condition is satisfied and the second condition is not satisfied.

3. The electrified vehicle according to claim 1, wherein:
the controller further includes
a remaining charge amount detection unit that detects a remaining charge amount of the power storage device, and
a remaining distance calculation unit that determines a remaining distance that is a travel distance to a destination;
the first condition is that the remaining charge amount of the power storage device is equal to or less than a predetermined threshold value; and
the second condition is that a distance that is travelable with the remaining charge amount of the power storage device is equal to or less than the remaining distance.

4. The electrified vehicle according to claim 3, wherein the destination is either a point selected and set by the occupant or a point provided with a charging facility and located ahead in a travel direction.
